(19) United States
(12) Patent Application Publication
(10) Pub. No.: US 2012/0195553 A1
(43) Pub. Date: Aug. 2, 2012

(54) ARRAYED WAVEGUIDE GRATING TYPE OPTICAL MULTIPLEXER AND DEMULTIPLEXER

(75) Inventors: Junichi HASEGAWA, Tokyo (JP); Kazutaka Nara, Tokyo (JP)

(73) Assignee: FURUKAWA ELECTRIC CO., LTD., Tokyo (JP)

(21) Appl. No.: 13/364,675

(22) Filed: Feb. 2, 2012

Related U.S. Application Data
(63) Continuation of application No. PCT/JP11/64400, filed on Jun. 23, 2011.

(30) Foreign Application Priority Data
Jul. 2, 2010 (JP) 2010-152244

(51) Int. Cl. G02B 6/34

(52) U.S. Cl. 385/37

(57) ABSTRACT

An arrayed waveguide grating type optical multiplexer and demultiplexer which reduces a package size although plural arrayed waveguide gratings are included, is provided, comprising plural arrayed waveguide gratings which are provided in parallel to one another on a substrate and each of which has a first waveguide, a first slab waveguide, an arrayed waveguide, a second slab waveguide, and a second waveguide, and also includes a waveguide chip divided into a first and second separated waveguide chip in the first or second slab waveguide in each of the arrayed waveguide gratings and a compensation member compensating a temperature dependent shift of a light transmission center wavelength in the arrayed waveguide grating by relatively moving the first and second waveguide chip when expanded or contracted according to a temperature change. The waveguide chip has a shape bending along a bending direction of the arrayed waveguide.

### CROSS-REFERENCE TO RELATED APPLICATIONS

This application is a continuation of International Application No. PCT/JP2011/064400, filed Jun. 23, 2011, which claims the benefit of Japanese Patent Application No. 2010-152244, filed Jul. 2, 2010. The contents of the aforementioned applications are incorporated herein by reference in their entities.

### BACKGROUND OF THE INVENTION

1. Field of the Invention

The present invention relates to an arrayed waveguide grating type optical multiplexer and demultiplexer having a function of a wavelength multiplexer and demultiplexer which unifies light beams having respective wavelengths different from one another and separates a light beam for each of the wavelengths, and specifically relates to an arrayed waveguide grating type optical multiplexer and demultiplexer which is made athermal (temperature independent).

2. Description of the Related Art

In an arrayed waveguide grating (AWG) playing an important role as a wavelength multiplexer and demultiplexer (MUX/DEMUX), a temperature dependence in the optical refractive index of silica-based glass causes a temperature dependence also in a center wavelength (transmission center wavelength).

The temperature dependence of the center wavelength in an AWG made of the silica-based glass is 0.011 nm/° C., and this is a non-negligibly large value for a use in a D-WDM (Dense-Wavelength Division Multiplexing) transmission system.

Accordingly, in the D-WDM transmission system which has been diversified in recent years, the AWG is strongly desired to be made athermal (temperature independent) without requiring a power supply.

A conventional arrayed waveguide grating type optical multiplexer and demultiplexer (athermal AWG module) which is made athermal by the use of a compensation plate is disclosed in Japanese Patent No. 3434489 (refer to FIG. 17). The arrayed waveguide grating type optical multiplexer and demultiplexer 100 shown in FIG. 17 includes a first waveguide 102 formed on a waveguide chip 114, a first slab waveguide 104 connected to the first waveguide 102, a second waveguide 106, a second slab waveguide 108 connected to the second waveguide 106, and an arrayed waveguide 110 connecting the first slab waveguide 104 and the second slab waveguide 108.

This arrayed waveguide grating type optical multiplexer and demultiplexer 100 is cut into two in a part for the first slab waveguide 104 and divided into an input side part 116 including a part 104A of the first slab waveguide 104 and an output side part 118 including the other part 104B of the first slab waveguide 104.

Then, these input side part 116 and output side part 118 are connected to each other by a compensation plate 112. With configuration, temperature change causes the compensation plate 112 to expand or contract and to move the part 104A of the first slab waveguide 104 and thereby it is possible to correct a wavelength shift due to the temperature change.

With this configuration, even when temperature changes, it is possible to take out light having the same wavelength as that of light input into the second waveguide 106, from the first waveguide 102.

### SUMMARY OF THE INVENTION

Typically, a wavelength multiplexer and demultiplexer includes two of an AWG for multiplexing and an AWG for demultiplexing in one package. Along with a higher functionality of the recent wavelength multiplexer and demultiplexer, the number of components to be included in a package tends to be increased and there is a problem that a package size is increased.

For example, if the plural arrayed waveguide gratings described in Japanese Patent No. 3764195 are included in one package, there arises a problem that the package size is considerably increased.

The present invention has been achieved to solve the above problem and aims at providing an arrayed waveguide grating type optical multiplexer and demultiplexer in which the package size is minimized even when plural arrayed waveguide gratings are included in one package.

An invention according to a first aspect of the present invention relates to an arrayed waveguide grating type optical multiplexer and demultiplexer, comprising: a waveguide chip having a plurality of arrayed waveguide gratings provided in parallel to one another on a substrate, each of the arrayed waveguide gratings including at least one first waveguide, a first slab waveguide connected to the first waveguide, an arrayed waveguide having one end connected to a side opposite to the first waveguide in the first slab waveguide and including a plurality of channel waveguides provided in parallel to one another, the channel waveguides having respective lengths different from one another and being bent in the same direction, a second slab waveguide connected to the other end of the arrayed waveguide, and a plurality of second waveguides connected in a state provided in parallel to one another to a side opposite to the arrayed waveguide in the second slab waveguide, wherein the waveguide chip is divided into a first separated waveguide chip and a second separated waveguide chip in the first slab waveguide or the second slab waveguide in each of the arrayed waveguide gratings; and a compensation member compensating a temperature dependent shift of a light transmission center wavelength in the arrayed waveguide grating by being expanded and contracted according to a temperature change so that the first and second separated waveguide chips are relatively moved, wherein the waveguide chip has a shape bending along a bending direction of the arrayed waveguide.

In the arrayed waveguide grating type optical multiplexer and demultiplexer according to the first aspect of the present invention, since the waveguide chip is formed on the substrate having the shape bending along the bending direction of the arrayed waveguide, it is possible to reduce a gap between the two arrayed waveguide gratings neighboring to each other when the plurality of arrayed waveguide gratings is provided in parallel to one another. Accordingly, it is possible to minimize the package size of the arrayed waveguide grating type optical multiplexer and demultiplexer.

An invention according to a second aspect of the present invention relates to an arrayed waveguide grating type optical multiplexer and demultiplexer, further comprising: a first base to which the first waveguide chip is fixed; and a second base which is provided apart from the first base and to which the second waveguide chip is fixed, wherein one side of the compensation member is fixed to one of the first base and the first waveguide chip, and the other side of the compensation member is fixed to the second base.

In the arrayed waveguide grating type optical multiplexer and demultiplexer according to the second aspect of the present invention, the number of the compensation members may be one for the plurality of arrayed waveguide gratings, and thereby the component is easily commonized and a low cost can be realized, and further, it is possible to minimize the package size of the arrayed waveguide grating type optical multiplexer and demultiplexer.

An invention according to a third aspect of the present invention relates to an arrayed waveguide grating type optical multiplexer and demultiplexer, wherein one of the first waveguide chip and the second waveguide chip includes one substrate.

An invention according to a fourth aspect of the present invention relates to an arrayed waveguide grating type optical multiplexer and demultiplexer, wherein each of the first waveguide chip and the second waveguide chip includes one substrate.

In these arrayed waveguide grating type optical multiplexers and demultiplexers, the plurality of arrayed waveguide gratings can be cut into two by one cut line. Accordingly, manufacturing can be performed in a high productivity.

An invention according to a fifth aspect of the present invention relates to an arrayed waveguide grating type optical multiplexer and demultiplexer, wherein a dividing part of the first waveguide chip and the second waveguide chip is sandwiched and held by a clip in a thickness direction.

According to the arrayed waveguide grating type optical multiplexer and demultiplexer of the fifth aspect, since the waveguide chips are sandwiched and held by the clip in the thickness direction at the dividing part of the arrayed waveguide grating divided into two, a shift in the thickness direction between one side and the other side of the arrayed waveguide grating divided into two is prevented from being caused by expansion or contraction of the compensation member. Accordingly, it is possible to reduce noise mixed in an optical signal to be output from the first waveguide or the second waveguide.

As explained above, the present invention provides an arrayed waveguide grating type optical multiplexer and demultiplexer in which the package size can be minimized even when the plurality of arrayed waveguide gratings is included in one package.

Further features of the present invention will become apparent from the following description of exemplary embodiments with reference to the attached drawings.

### BRIEF DESCRIPTION OF THE DRAWINGS

FIG. 1A is a plan view showing a configuration of an arrayed waveguide grating type optical multiplexer and demultiplexer according to Embodiment 1.

FIG. 1B is a side view showing a configuration of an arrayed waveguide grating type optical multiplexer and demultiplexer according to Embodiment 1.

FIG. 2A is a plan view showing a configuration of an arrayed waveguide grating type optical multiplexer and demultiplexer according to Embodiment 2.

FIG. 2B is a side view showing a configuration of an arrayed waveguide grating type optical multiplexer and demultiplexer according to Embodiment 2.

FIG. 3A is a plan view showing a configuration of an arrayed waveguide grating type optical multiplexer and demultiplexer according to Embodiment 3.

FIG. 3B is a side view showing a configuration of an arrayed waveguide grating type optical multiplexer and demultiplexer according to Embodiment 3.

FIG. 4A is a plan view showing a configuration of an arrayed waveguide grating type optical multiplexer and demultiplexer according to Embodiment 4.

FIG. 4B is a side view showing a configuration of an arrayed waveguide grating type optical multiplexer and demultiplexer according to Embodiment 4.

FIG. 5A is a plan view showing a configuration of an arrayed waveguide grating type optical multiplexer and demultiplexer according to Embodiment 5.

FIG. 5B is a side view showing a configuration of an arrayed waveguide grating type optical multiplexer and demultiplexer according to Embodiment 5.

FIG. 6 is a cross-sectional view showing a cross section when a clip and a neighborhood thereof are cut in the thickness direction along the 6-6 line in FIG. 5A in an arrayed waveguide grating type optical multiplexer and demultiplexer according to Embodiment 5.

FIG. 7A is a plan view showing a configuration of an arrayed waveguide grating type optical multiplexer and demultiplexer according to Embodiment 6.

FIG. 7B is a side view showing a configuration of an arrayed waveguide grating type optical multiplexer and demultiplexer according to Embodiment 6.

FIG. 8A is a plan view showing a configuration of an arrayed waveguide grating type optical multiplexer and demultiplexer according to Embodiment 7.

FIG. 8B is a side view showing a configuration of an arrayed waveguide grating type optical multiplexer and demultiplexer according to Embodiment 7.

FIG. 9 is an explanatory diagram showing a state in which plural arrayed waveguide gratings are formed on a wafer.

FIG. 10 is an explanatory diagram showing a state in which an individual waveguide chip is cut out from a wafer on which plural arrayed waveguide gratings are formed.

FIG. 11 is an explanatory diagram showing a state in which an individual waveguide chip is cut out from a wafer on which plural arrayed waveguide gratings are formed.

FIG. 12 is an explanatory diagram showing a state in which an individual waveguide chip is cut out from a wafer on which plural arrayed waveguide gratings are formed.

FIG. 13 is a plan view showing a configuration of an individual waveguide chip cut out from the wafer

FIG. 14 is a plan view showing an example of a waveguide chip, which is cut out from the wafer, including two arrayed waveguide gratings on one substrate.

FIG. 15 is a graph showing an evaluation result of a temperature characteristic in an arrayed waveguide grating type optical multiplexer and demultiplexer according to Example 1.

FIG. 16 is a table showing a circuit parameter of an arrayed waveguide grating to be used for determining the length of a compensation plate in an arrayed waveguide grating type optical multiplexer and demultiplexer according to Embodiment 1.

FIG. 17 is a plan view showing a configuration of an example of a conventional arrayed waveguide grating type optical multiplexer and demultiplexer.

### DESCRIPTION OF THE EMBODIMENTS

### 1. Embodiment 1

Preferred embodiments of the present invention will now be described in detail in accordance with the accompanying drawings.

In the following, an example of an arrayed waveguide grating type optical multiplexer and demultiplexer according to the present invention will be explained.

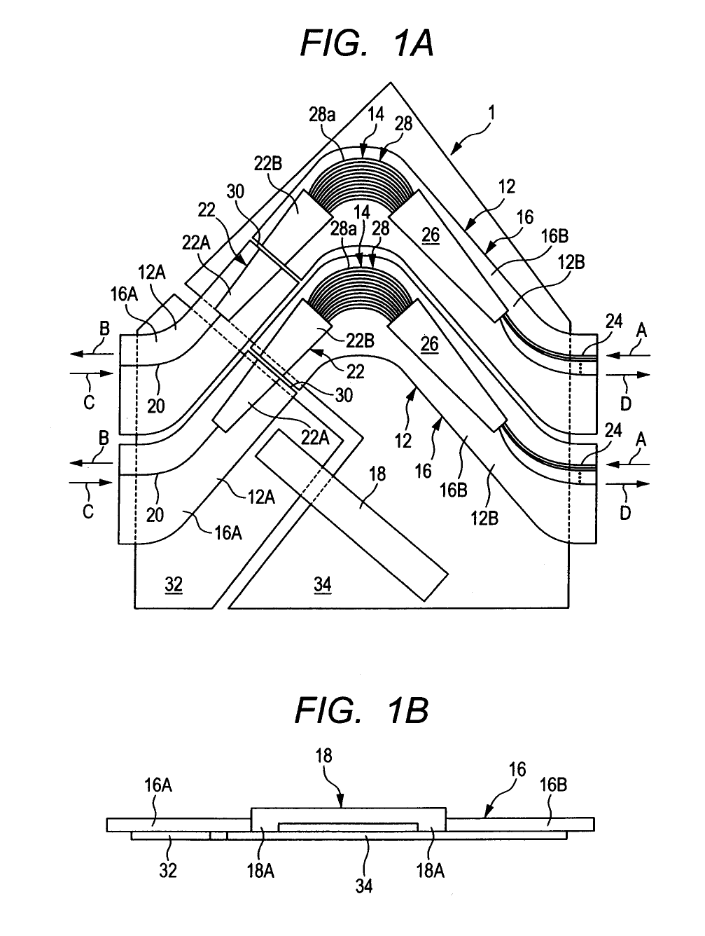

FIG. 1A and FIG. 1B show a plan view and a side view of an arrayed waveguide grating type optical multiplexer and demultiplexer 1 according to Embodiment 1, respectively. The arrayed waveguide grating type optical multiplexer and demultiplexer 1 includes a waveguide chip 16 on which an arrayed waveguide grating 14 is formed, bases 32 and 34, and a compensation member 18.

The waveguide chip 16 includes a substrate 12 made of silicon and the two arrayed waveguide gratings 14 formed on the substrate 12 and provided in parallel to each other, and has an approximately boomerang-like planar shape cut in a curved shape along the outline of the arrayed waveguide grating 14. The substrate 12 is divided in a bending direction of the arrayed waveguide grating 14 and one arrayed waveguide grating 14 is formed on one substrate 12. Each of the arrayed waveguide gratings 14 includes at least one first waveguide 20 into which an optical signal is input, a first slab waveguide 22 connected to the output side of the first waveguide 20, an arrayed waveguide 28, which is connected to the output side of the first slab waveguide 22 and also includes plural channel waveguides 28a provided in parallel to one another having respective lengths different from one another, a second slab waveguide 26 connected to the output side of the arrayed waveguide 28, and plural second waveguides 24 which are connected in a state provided in parallel to one another to the output side of the second slab waveguide 26.

Note that, while the present embodiment shows an example in which the number of the arrayed waveguide gratings 14 is two, the number of the arrayed waveguide gratings 14 is not limited to two and may be three or larger.

Here, the arrayed waveguide grating 14 is a planar lightwave circuit (PLC) in which an optical waveguide is fabricated to include a core and a cladding which are formed on the silicon substrate 12 by a combination of a flame hydrolysis deposition method (FHD method), an optical fiber manufacturing technique, and a semiconductor micro-fabrication technique. A quartz substrate may be used as the substrate instead of the silicon substrate.

In each of the waveguide chips 16, the first slab waveguide 22 is divided together with the substrate 12 by a cut plane 30 which is a vertical plane crossing the optical axis of the first slab waveguide 22.

That is, the waveguide chip 16 is divided by the cut plane 30 into each of a first separated waveguide chip 16A and a second separated waveguide chip 16B. Further, the first slab waveguide 22 is divided by the cut plane 30 into two of a first separated slab waveguide 22A and a second separated slab waveguide 22B in each of the waveguide chips 16. Note that the cut plane 30 in each of the waveguide chips 16 is formed at approximately the same position in the first slab waveguide 22, and, when two arrayed waveguide gratings 14 are provided in parallel to each other, each of the cut planes 30 is not disposed on the same straight line.

The first separated slab waveguide 22A denotes the side connected with the first waveguide 20 in the first slab waveguide 22 divided into two, and the second separated slab waveguide 22B denotes the side connected with the arrayed waveguide 28. Then, the first separated waveguide chip 16A denotes the side including the first separated slab waveguide 22A in the waveguide chip 16 divided into two, and the second separated waveguide chip 16B denotes the side including the second separated slab waveguide 22B.

Further, in the substrate 12 divided into two by the cut plane 30, a substrate on the side where the first separated waveguide chip 16A is formed is called a first substrate 12A, and a substrate on the side where the second separated waveguide chip 16B is formed is called a second substrate 12B.

The waveguide chip 16 is fixed to the bases 32 and 34, and the first separated waveguide chip 16A and the second separated waveguide chip 16B are fixed to a first glass plate 32 which is an example of the first base and a second glass plate 34 which is an example of the second base, respectively. Note that, while the cut plane 30 in one of the waveguide chips 16 is disposed at a dividing position of the first glass plate 32 and the second glass plate 34, the cut plane 30 of the other one of the waveguide chips 16 is disposed on the second glass plate 34.

Further, the first substrate 12A is bonded and fixed to the first glass plate 32 at a part contacting the first glass plate 32, and the second substrate 12B is bonded and fixed to the second glass plate 34 at a part contacting the second glass plate 34. Note that a part where the first substrate 12A contacts the second glass plate 34 is not bonded or fixed.

Here, since ultraviolet light can be transmitted, when either of the first glass plate 32 and the second glass plate 34 is made of silica glass, ultraviolet curable adhesive can be preferably used for bonding the first separated waveguide chip 16A to the first glass plate 32 and for bonding the second separated waveguide chip 16B to the second glass plate 34. Note that a part for the arrayed waveguide 28 in the second separated waveguide chip 16B is preferably not bonded to the second glass plate 34. When the part for the arrayed waveguide 28 is not bonded, an influence to the arrayed waveguide 28 caused by a difference between the linear expansion coefficient of the second separated waveguide chip 16B and the linear expansion coefficient of the second glass plate 34 can be suppressed when ambient temperature is increased or decreased, and crosstalk can be reduced.

Moreover, in the waveguide chip 16, the both sides of the substrate 12 may be connected with each other at least at a part thereof if only the arrayed waveguide grating 14 is cut into two by the cut plane 30 in a part for the first slab waveguide 22 or the second slab waveguide 26 and a movement amount can be secured for a relative position of the first slab waveguide 22 and the second slab waveguide 26.

Moreover, the arrayed waveguide grating type optical multiplexer and demultiplexer 1 is provided with a rectangle-shaped compensation member 18 which crosses over the first glass plate 32 and the second glass plate 34, and one side of which is fixed to the upper surface of the first glass plate 32 with adhesive and the other side of which is fixed to the upper surface of the second glass plate 34 with adhesive. This compensation member 18 is disposed in a manner such that a long side (longitudinal direction) thereof is parallel to the extension direction of the cut plane 30. Here, the present embodiment is configured to use a metal plate made of copper or pure aluminum (JIS:A1050) for the compensation member 18. As shown in FIG. 1B, leg parts 18A are provided to protrude from both ends of the compensation member 18, respectively, and these leg parts 18A are fixed to the first glass plate and the second glass plate 34 with adhesive, respectively. Thereby, respective bonding areas of the compensation member 18 with the first glass plate 32 and the second glass plate 34 are made constant.

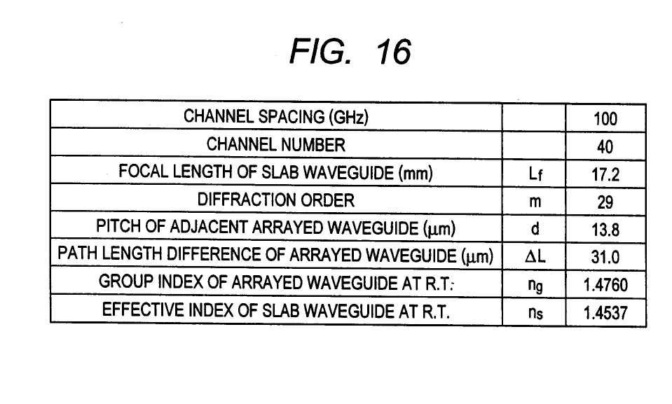

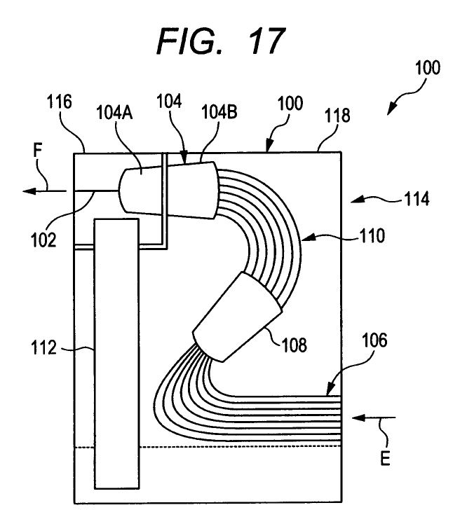

The length of this compensation member 18 is calculated from the following Formula I by the use of the circuit parameters of the arrayed waveguide grating 14 shown in FIG. 16, and the length is 18 mm in the present embodiment.

$$dx = \frac{{L}_{f} Δ L}{{n}_{s} d {λ}_{0}} {n}_{g} \frac{d λ}{d T} \qquad ( Formula 1 )$$

In this configuration, when temperature changes, a light collection position of the first slab waveguide 22 (light collection position of the first separated slab waveguide 22A in the first slab waveguide 22) changes by dx. However, by the expansion or contraction by dx of the compensation member 18 according to the temperature change, the first glass plate 32 and the second glass plate 34 are moved relatively along the cut plane 30. Thereby, the first separated slab waveguide 22A also is moved relatively against the second separated slab waveguide 22B along the cut plane 30. Accordingly, the light collection position of the first slab waveguide 22 is corrected (dx−dx=0).

In each of the waveguide chips 16, a wavelength multiplexed optical signal multiplexing optical signals having respective wavelengths different from one another is input into the first waveguide 20, or a wavelength multiplexed optical signal is output from the first waveguide 20. The first slab waveguide 22 has a function of demultiplexing the wavelength multiplexed optical signal input from the first waveguide 20 for each wavelength and a function of multiplexing optical signals which have respective wavelengths different from one another and are propagated through the arrayed waveguide 28.

In the arrayed waveguide 28, the channel waveguides 28a each having a function of transmitting an optical signal for each wavelength are provided at a predetermined pitch d in a number of, for example, 100, corresponding to the number of channels of the wavelength multiplexed optical signal input into the first waveguide 20. In the present embodiment, the pitch d of the arrayed waveguide 28 is set to be 13.8 μm, but the pitch d is not limited to this length.

Further, since the optical signal having a different wavelength propagates through each of the channel waveguides 28a, each of the channel waveguides 28a has a different length corresponding to the wavelength of the light to be propagated. The lengths of the neighboring two channel waveguides 28a are different from each other by a setup amount ΔL. In the present embodiment, the setup amount ΔL is set as 31.0 μm as shown in FIG. 16.

Moreover, since the channel waveguides 28a are disposed from one side edge to the other side edge of the waveguide chip 16 in the ascending order in length, the whole arrayed waveguide grating 14 is bent in a specified direction as shown in FIG. 1A.

The second waveguides 24 are provided in a number corresponding to the number of the channels of the wavelength multiplexed optical signal input into the first waveguide 20, that is, in the same number as that of the channel waveguides 28a.

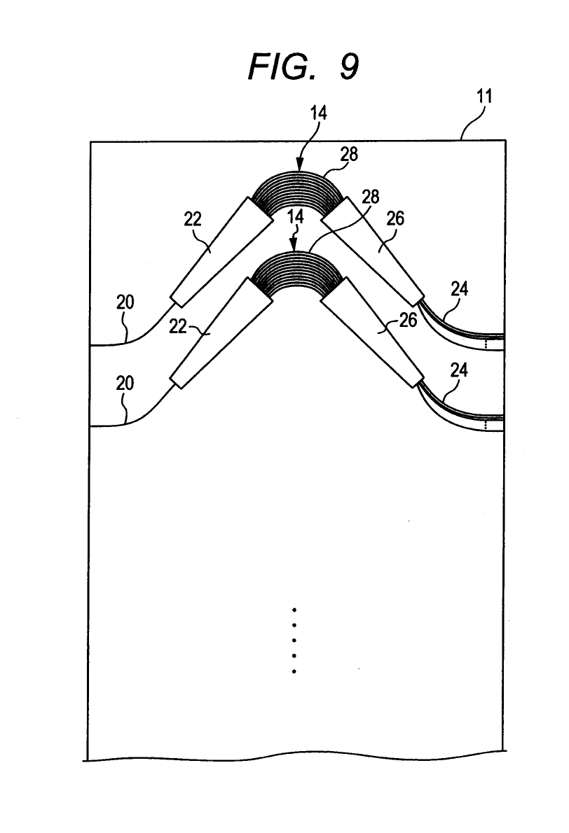

Next, a manufacturing process of the arrayed waveguide grating type optical multiplexer and demultiplexer 1 will be explained. As shown in FIG. 9, a predetermined number of the arrayed waveguide gratings 14 are formed on a silicon wafer 11 in a condensed state.

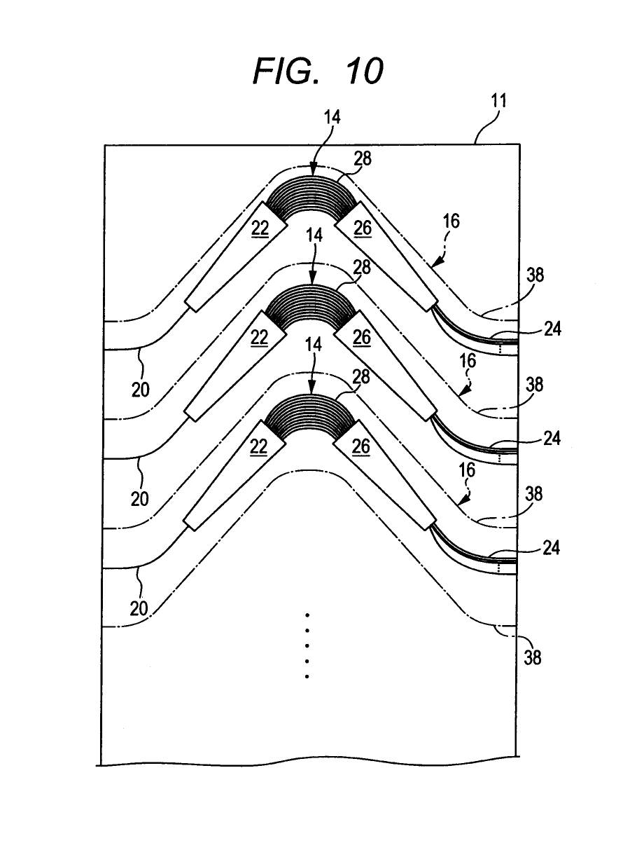

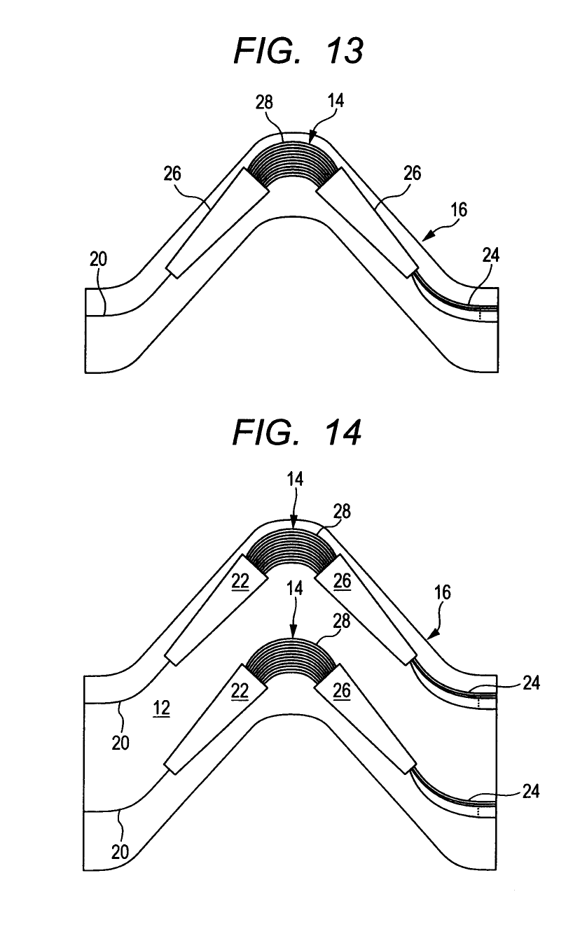

Next, the silicon wafer 11, on which the arrayed waveguide gratings 14 are formed, is cut in a curved shape along a cut line 38 by the use of a laser beam machine (e.g., CO₂ laser) as shown in FIG. 10. Thereby, the predetermined number of the waveguide chips 16, each of which includes the substrate 12 having the boomerang-like outer shape, are obtained as shown in FIG. 13.

After the fabrication of the waveguide chip 16, the waveguide chip 16 is cut in the direction perpendicular to the optical axis (center line) of the first slab waveguide 22 together with the substrate 12 in the part for the first slab waveguide 22, and divided into two of the first separated waveguide chip 16A and the second separated waveguide chip 16B (refer to FIG. 1A). Next, the first separated waveguide chip 16A and the second separated waveguide 16B fabricated in this manner are bonded and fixed to the first glass plate 32 and the second glass plate 34, respectively.

Lastly, one of the legs 18A of the compensation member 18 is fixed with adhesive to the upper surface of the first glass plate 32 and the other leg 18A is fixed with adhesive to the upper surface of the second glass plate 34 in a manner such that a long side of the compensation member 18 is parallel to the extension direction of the cut plane 30. At this time, the compensation member 18 is attached in a manner such that a center wavelength of the arrayed waveguide grating 14 matches a wavelength of the ITU-T grid. By the above process, the arrayed waveguide grating type optical multiplexer and demultiplexer 1 is fabricated.

### (Operation and Advantage)

Next, the operation of the arrayed waveguide grating type optical multiplexer and demultiplexer 1 will be explained.

When the arrayed waveguide grating type optical multiplexer and demultiplexer 1 is used for multiplexing (MUX), in each of the waveguide chips 16, as shown in FIG. 1A by the arrow A, plural optical signals having respective wavelengths different from one another (λ1 to λn) are input individually from the second waveguides 24.

The input optical signals (λ1 to λn) are input individually into the respective channel waveguides 28a in the arrayed waveguide grating 14 through the second slab waveguide 26.

The optical signals (λ1 to λn) propagated in the respective channel waveguides 28a are multiplexed in the first slab waveguide 22 and output from the first waveguide 20 as a wavelength multiplexed optical signal as shown in FIG. 1A by the arrow B.

Here, when temperature changes, a light collection position of the first slab waveguide 22 (light collection position of the second separated slab waveguide 22B in the first slab waveguide 22) changes, but the first separated slab waveguide 22A is moved relatively against the second separated slab waveguide 22B by the expansion or contraction of the compensation member 18 and the light collection position is corrected. Thereby, even when temperature changes, it is possible to take out the optical signal having the same wavelength from the first waveguide 20. That is, in the arrayed waveguide grating 14, a wavelength multiplexed optical signal multiplexed with the plural optical signals having the same wavelengths (λ1 to λn) as those of the input plural optical signals (λ1 to λn), respectively, is output from the first waveguide 20.

On the other hand, when the arrayed waveguide grating type optical multiplexer and demultiplexer 1 is used for demultiplexing (DEMUX), in each of the waveguide chips 16, as shown in FIG. 1A by the arrow C, a wavelength multiplexed optical signal multiplexed with the plural optical signals having respective wavelengths different from one another (λ1 to λn) is input from the first waveguide 20.

The input wavelength multiplexed optical signal is demultiplexed in the first slab waveguide 22 into n optical signals having respective wavelengths (λ1, λ2, λ3, λ3, . . . , λn) and the n optical signals are input individually into the channel waveguides 28a.

The optical signals propagated individually through the channel waveguides 28a pass through the second slab waveguide 26 and are output individually from the second waveguides 24 as shown in FIG. 1A by the arrow D. That is, in the arrayed waveguide grating 14, the wavelength multiplexed optical signal multiplexed with the plural optical signals having respective wavelengths different from one another (λ1 to λn) is input from the first waveguide 20 and demultiplexed for each of the wavelengths to be output from the second waveguide 24.

Here, when temperature changes, the light collection position in the first separated slab waveguide 22A of the first slab waveguide 22 changes but the first separated slab waveguide 22A is moved relatively against the second separated slab waveguide 22B by the expansion or contraction of the compensation member 18 and the light collection position is corrected. Thereby, even when temperature changes, the optical signal having the same wavelength is taken out from the second waveguide 24. That is, the optical signal having the same wavelength as each of the wavelengths λ1 to λn in the input wavelength multiplexed optical signal is output individually from the second waveguide 24.

In the arrayed waveguide grating type optical multiplexer and demultiplexer 1, since the compensation member 18 is fixed to the first glass plate 32 and the second glass plate 34, it is possible to determine the respective shapes of the first separated waveguide chip 16A and the second separated waveguide chip 16B without consideration of a space in the waveguide chip 16 where the compensation member 18 is to be bonded.

Further, the waveguide chip 16 as a whole is configured to have the approximately boomerang-like planar shape which is bent along the bending direction of the arrayed waveguide grating 14.

Accordingly, although having the plural waveguide chips 16, by means of reducing the gap between the two waveguide chips 16 neighboring each other, the arrayed waveguide grating type optical multiplexer and demultiplexer 1 can be formed in an area almost as same as that of the arrayed waveguide grating type optical multiplexer and demultiplexer which has only one waveguide chip.

Therefore, the package size can be minimized.

Further, either of the waveguide chips 16 can have the same configuration and thereby manufacturing is easily performed and loss variation can be suppressed. Further, the number of the compensation members 18 may be one for the plural arrayed waveguide gratings 14 and thereby the component is easily commonized and cost merit is easily obtained.

Further, since the waveguide chip 16 is configured to have the approximately boomerang-like outer shape by means of cutting each of the plural arrayed waveguide gratings 14 formed on the single silicon wafer 11 in a curved shape along the outline of each of the arrayed waveguide gratings 14 by using the laser beam machine, the number of the waveguide chips 16 fabricated from the single silicon wafer 11 can be increased compared to a case in which the waveguide chip 16 has an rectangular outer shape.

Further, the first separated slab waveguide 22A moves relatively against the second separated slab waveguide 22B along the cut plane 30 when the compensation member 18 is fixed to the first glass plate 32 and the second glass plate 34 so as to make a long side thereof parallel to the longitudinal direction of the cut plane 30. In this manner, by means of causing the divided first separated slab waveguide 22A to move relatively against the second separated slab waveguide 22B along the cut plane 30, the light collection position of the first slab waveguide 22 can be corrected precisely.

Further, the waveguide chip 16 is cut in the part for the first slab waveguide 22 by the cut plane 30 in the direction perpendicular to the optical axis (center line) thereof. Thereby, the first separated waveguide chip 16A and the second separated waveguide chip 16B move relatively in the direction perpendicular to the optical axis and therefore the light collection position of the first slab waveguide 22 can be corrected precisely.

Further, by means of causing the waveguide chip 16 to have the boomerang-like outer shape along the bending of the arrayed waveguide grating 14, a cut line does not remain to the chip and thereby it is possible to improve a mechanical strength of the waveguide chip 16 against shock, vibration, or the like, compared to a case in which the chip is cut by the use of a dicing machine.

### 2. Embodiment 2

In the following, another example of the arrayed waveguide grating type optical multiplexer and demultiplexer according to the present invention will be explained.

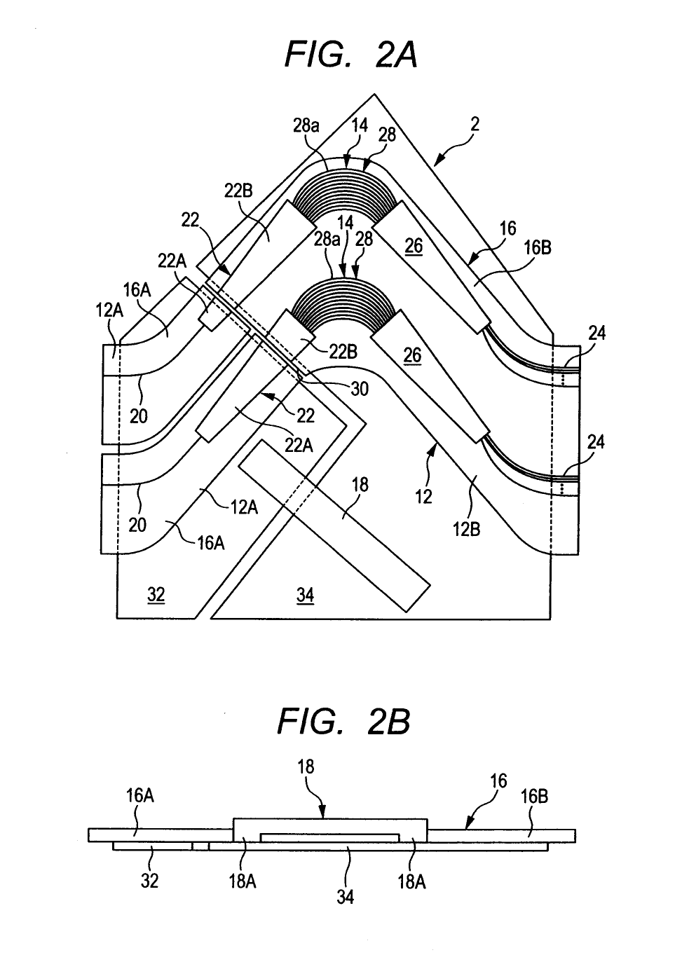

FIG. 2A and FIG. 2B show a plan view and a side view of an arrayed waveguide grating type optical multiplexer and demultiplexer 2 according to Embodiment 2, respectively. The arrayed waveguide grating type optical multiplexer and demultiplexer 2 according to Embodiment 2 includes two arrayed waveguide gratings 14 provided in parallel to each other as same as Embodiment 1. Note that the number of the arrayed waveguide gratings 14 is not limited to two and may be three or larger.

As shown in FIG. 2A, the waveguide chip 16 is cut by one cut plane 30 in a part for respective first slab waveguides 22 in the two arrayed waveguide gratings 14 and divided into a first separated waveguide chip 16A and a second separated waveguide chip 16B. Accordingly, the first slab waveguide 22 is also separated by the cut plane 30 into a first separated slab waveguide 22A and a second separated slab waveguide 22B. While the cut planes 30 of the two first slab waveguides 22 are formed at the same positions of the first slab waveguides 22, respectively, in Embodiment 1, the cut planes 30 of the two first slab waveguides 22 are formed at different positions thereof and arranged so as to be disposed on the same straight line, respectively, in Embodiment 2.

In the first separated waveguide chip 16A, a part for the first waveguide 20 and the first separated slab waveguide 22A in the arrayed waveguide grating 14 is formed. Then, a first substrate 12A is divided into two for the respective arrayed waveguide gratings 14 and each of the first substrates 12A is fixed to a first glass plate 32.

On the other hand, in the second separated waveguide chip 16B, the remaining part of the arrayed waveguide grating 14, that is, the second separated slab waveguide 22B, an arrayed waveguide 28, a second slab waveguide 26, and a second waveguide 24 are formed. The number of second substrates 12B is one for the two arrayed waveguide gratings 14 and the second substrate 12B is fixed to the second glass plate 34.

The arrayed waveguide grating type optical multiplexer and demultiplexer 2 is the same as the arrayed waveguide grating type optical multiplexer and demultiplexer according to Embodiment 1 in a point except the above described one, specifically, in respective configurations and the like of the arrayed waveguide grating 14 and a compensation member 18.

Next, a manufacturing process of the arrayed waveguide grating type optical multiplexer and demultiplexer 2 will be explained.

As shown in FIG. 9, a predetermined number of the arrayed waveguide gratings 14 are formed on a silicon wafer 11 in a condensed state.

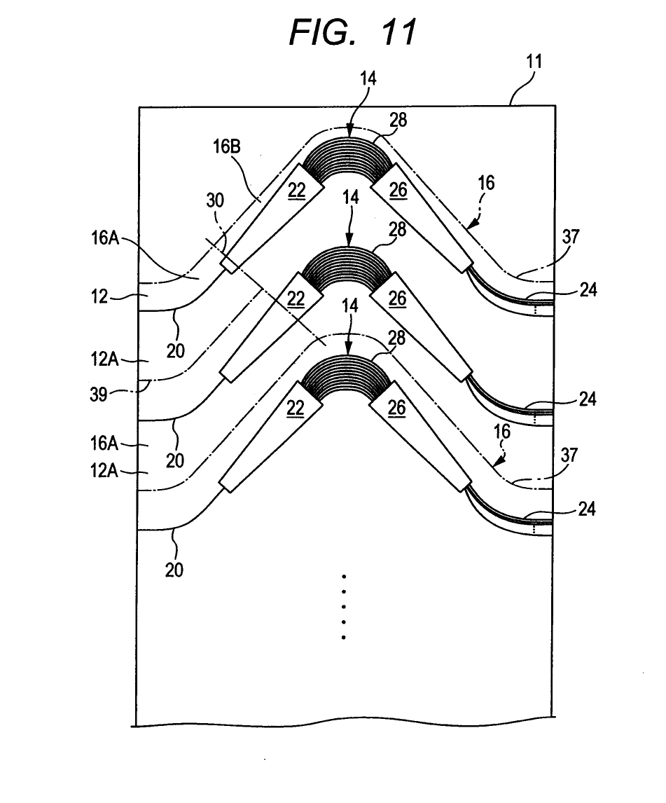

Next, the wafer 11 on which the arrayed waveguide gratings 14 are formed is cut in a curved shape along a cut line 37 by the use of the laser beam machine (e.g., CO₂ laser) as shown in FIG. 11.

Thereby, as shown in FIG. 14, a predetermined number of the waveguide chips 16, in each of which the substrate 12 has an outer shape bent in a boomerang shape along the bending of the arrayed waveguide grating 14 and also the two arrayed waveguide gratings 14 are provided in parallel to each other, are obtained.

After the fabrication of the waveguide chip 16, as shown in FIG. 11, the waveguide chip 16 is cut together with the substrate 12 in the part for the first slab waveguide 22 in the direction perpendicular to the optical axis (center line) of the first slab waveguide 22 and divided into two of the first separated waveguide chip 16A and the second separated waveguide chip 16B.

Next, as shown in FIG. 11, a part between the arrayed waveguide gratings 14 in the first separated waveguide chip 16A is cut along a cut line 39 and the first substrate 12A is divided into two.

Then, as shown in FIG. 2A, the first separated waveguide chip 16A and the second separated waveguide chip 16B are bonded and fixed to the first glass plate 32 and the second glass plate 34, respectively.

Lastly, one leg 18A of the compensation member 18 is fixed with adhesive to the upper surface of the first glass plate 32 and the other leg 18A is fixed with adhesive to the upper surface of the second glass plate 34 in a manner such that a long side of the compensation member 18 is parallel to the extension direction of the cut plane 30 and also a center wavelength of the arrayed waveguide grating 14 matches a wavelength of the ITU-T grid. By the above process, the arrayed waveguide grating type optical multiplexer and demultiplexer 2 is fabricated.

### 3. Embodiment 3

In the following, still another example of the arrayed waveguide grating type optical multiplexer and demultiplexer according to the present invention will be explained.

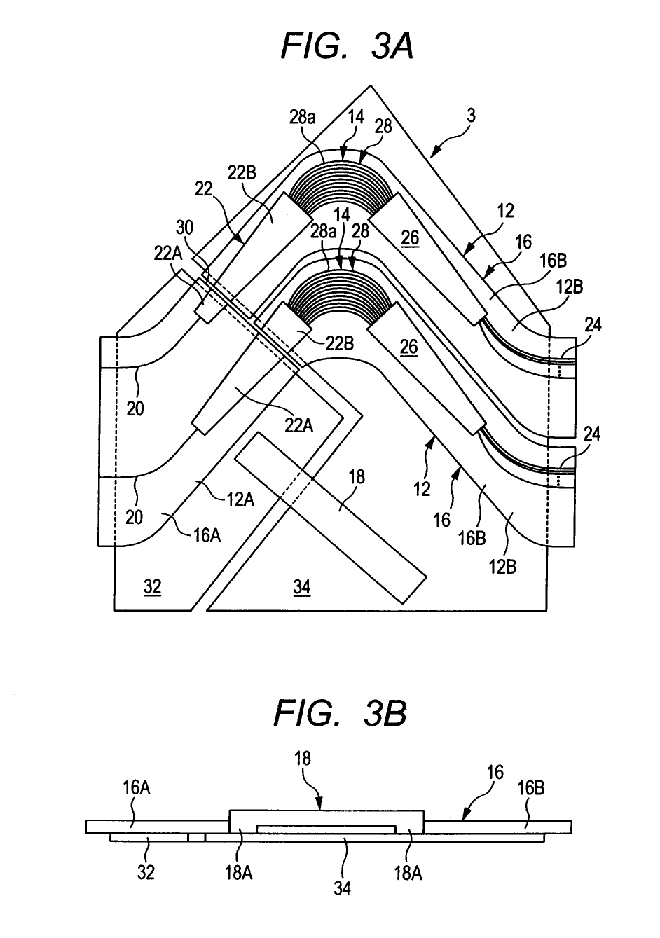

FIG. 3A and FIG. 3B show a plan view and a side view of an arrayed waveguide grating type optical multiplexer and demultiplexer 3 according to Embodiment 3, respectively. The arrayed waveguide grating type optical multiplexer and demultiplexer 3 according to Embodiment 3, as with Embodiment 1, includes two arrayed waveguide gratings 14 provided in parallel to each other. Note that the number of the arrayed waveguide gratings 14 is not limited to two and may be three or larger.

As shown in FIG. 3A, a waveguide chip 16, as with Embodiment 2, is cut by one cut plane 30 in a part for respective first slab waveguides 22 in the two arrayed waveguide gratings 14 and divided into a first separated waveguide chip 16A and a second separated waveguide chip 16B. Accordingly, the first slab waveguide 22 is also cut by the cut plane 30 and divided into a first separated slab waveguide 22A and a second separated slab waveguide 22B.

In the first separated waveguide chip 16A, a part for a first waveguide 20 and the first separated slab waveguide 22A in the arrayed waveguide grating 14 is formed. Then, the number of first substrates 12A is one for the two arrayed waveguide gratings 14 and the first substrate 12A is fixed to a first glass plate 32.

On the other hand, in the second separated waveguide chip 16B, the remaining part of the arrayed waveguide grating 14, that is, the second separated slab waveguide 22B, an arrayed waveguide 28, a second slab waveguide 26, and a second waveguide 24 are formed. Then, the second substrates 12B is configured to be divided into two for the respective arrayed waveguide gratings 14 and each of the second substrates 12B is fixed to a second glass plate 34.

The arrayed waveguide grating type optical multiplexer and demultiplexer 3 is the same as the arrayed waveguide grating type optical multiplexer and demultiplexer according to Embodiment 1 in a point except the above one, specifically, in respective configurations and the like of the arrayed waveguide grating 14 and a compensation member 18.

Next, a manufacturing process of the arrayed waveguide grating type optical multiplexer and demultiplexer 3 will be explained.

As shown in FIG. 9, a predetermined number of the arrayed waveguide gratings 14 are formed on one silicon wafer 11 in a condensed state.

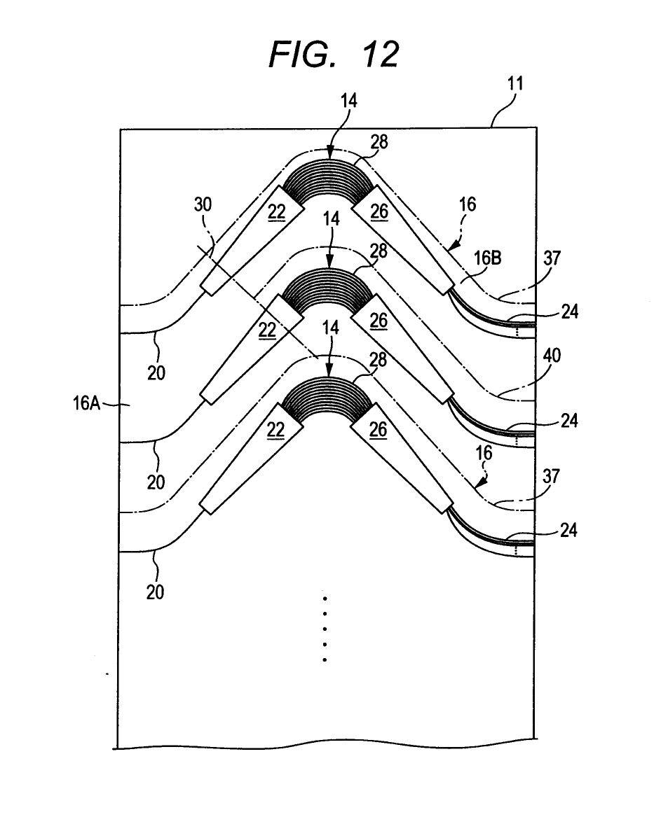

Next, the wafer 11 on which the arrayed waveguide gratings 14 are formed is cut in a curved shape along a cut line 37 by the use of the laser beam machine (e.g., CO₂ laser) as shown in FIG. 12.

Thereby, as shown in FIG. 14, a predetermined number of waveguide chips 16, in each of which a substrate 12 has an outer shape bent in a boomerang shape along the bending of the arrayed waveguide grating 14 and also the two arrayed waveguide grating 14 are provided in parallel to each other, are obtained.

After the fabrication of the waveguide chip 16, as shown in FIG. 12, the waveguide chip 16 is cut together with the substrate 12 in the part for the first slab waveguide 22 in the direction perpendicular to the optical axis (center line) of the first slab waveguide 22 and divided into two of the first separated waveguide chip 16A and the second separated waveguide chip 16B.

Next, as shown in FIG. 12, a part between the arrayed waveguide gratings 14 in the second separated waveguide chip 16B is cut along a cut line 40 and the second substrate 12B is divided into two.

Then, as shown in FIG. 3A, the first separated waveguide chip 16A and the second separated waveguide chip 16B are bonded and fixed to the first glass plate 32 and the second glass plate 34, respectively.

Lastly, one leg 18A of the compensation member 18 is fixed with adhesive to the upper surface of the first glass plate 32 and the other leg 18A is fixed with adhesive to the upper surface of the second glass plate 34 in a manner such that a long side of the compensation member 18 is parallel to the extension direction of the cut plane 30 and also a center wavelength of the arrayed waveguide grating 14 matches a wavelength of the ITU-T grid. By the above process, the arrayed waveguide grating type optical multiplexer and demultiplexer 3 is fabricated.

### 4. Embodiment 4

In the following, still another example of the arrayed waveguide grating type optical multiplexer and demultiplexer according to the present invention will be explained.

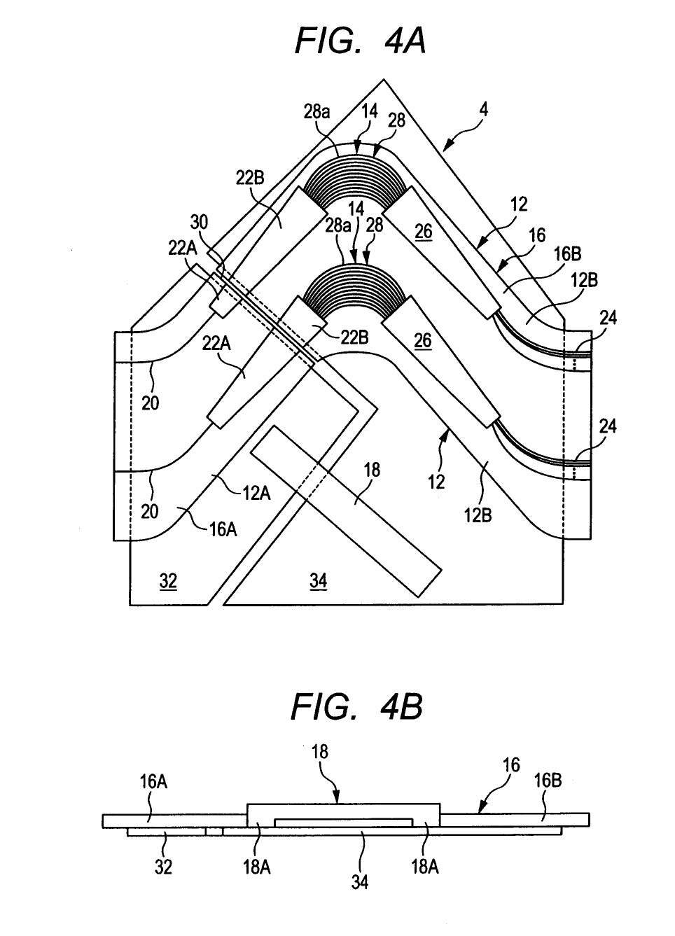

FIG. 4A and FIG. 4B show a plan view and a side view of an arrayed waveguide grating type optical multiplexer and demultiplexer 4 according to Embodiment 4, respectively. The arrayed waveguide grating type optical multiplexer and demultiplexer 4 according to Embodiment 4, as with Embodiment 1, includes two arrayed waveguide gratings 14 provided in parallel to each other. Note that the number of the arrayed waveguide gratings 14 is not limited to two and may be three or larger.

As shown in FIG. 4A, a waveguide chip 16, as with Embodiment 2, is cut by one cut plane 30 in a part for respective first slab waveguides 22 in the two arrayed waveguide gratings 14 and divided into a first separated waveguide chip 16A and a second separated waveguide chip 16B. Accordingly, the first slab waveguide 22 is also cut by the cut plane 30 and divided into a first separated slab waveguide 22A and a second separated slab waveguide 22B.

In the first separated waveguide chip 16A, a part for a first waveguide 20 and the first separated slab waveguide 22A in the arrayed waveguide grating 14 is formed. Then, the number of first substrates 12A is one for the two arrayed waveguide gratings 14 and the first substrate 12A is fixed to a first glass plate 32.

On the other hand, in the second separated waveguide chip 16B, the remaining part of the arrayed waveguide grating 14, that is, the second separated slab waveguide 22B, an arrayed waveguide 28, a second slab waveguide 26, and a second waveguide 24 are formed. Then, the number of second substrates 12B is configured to be one for the two arrayed waveguide gratings 14 as same as in the first separated waveguide chip 16A and the second substrates 12B is fixed to a second glass plate 34.

The arrayed waveguide grating type optical multiplexer and demultiplexer 4 is the same as the arrayed waveguide grating type optical multiplexer and demultiplexer according to Embodiment 1 in a point except the above one, specifically, in respective configurations and the like of the arrayed waveguide grating 14 and a compensation member 18.

Next, a manufacturing process of the arrayed waveguide grating type optical multiplexer and demultiplexer 4 will be explained.

As shown in FIG. 9, a predetermined number of the arrayed waveguide gratings 14 are formed on one silicon wafer 11 in a condensed state.

Next, the wafer 11 on which the arrayed waveguide gratings 14 are formed is cut in a curved shape along a cut line 37 by the use of the laser beam machine (e.g., CO₂ laser) as shown in FIG. 11 or FIG. 12.

Thereby, as shown in FIG. 14, a predetermined number of waveguide chips 16, in each of which a substrate 12 has an outer shape bent in a boomerang shape along the bending of the arrayed waveguide grating 14 and also the two arrayed waveguide gratings 14 are provided in parallel to each other, are obtained.

After the fabrication of the waveguide chip 16, as shown in FIG. 11 or FIG. 12, the waveguide chip 16 is cut together with the substrate 12 in the part for the first slab waveguide 22 in the direction perpendicular to the optical axis (center line) of the first slab waveguide 22 and divided into two of the first separated waveguide chip 16A and the second separated waveguide chip 16B.

Next, the first separated waveguide chip 16A and the second separated waveguide chip 16B are bonded and fixed to the first glass plate 32 and the second glass plate 34, respectively.

Lastly, one leg 18A of the compensation member 18 is fixed with adhesive to the upper surface of the first glass plate 32 and the other leg 18A is fixed with adhesive to the upper surface of the second glass plate 34 in a manner such that a long side of the compensation member 18 is parallel to the extension direction of the cut plane 30 and also a center wavelength of the arrayed waveguide grating 14 matches a wavelength of the ITU-T grid. By the above process, the arrayed waveguide grating type optical multiplexer and demultiplexer 4 is fabricated.

The respective arrayed waveguide grating type optical multiplexers and demultiplexers 2 to 4 of Embodiments 2 to 4 have the following advantage in addition to the advantage of the arrayed waveguide grating type optical multiplexer and demultiplexer of Embodiment 1.

That is, in the respective arrayed waveguide grating type optical multiplexers and demultiplexers 2 to 4 of Embodiments 2 to 4, the waveguide chip 16 is divided into the first separated waveguide chip 16A and the second separated waveguide chip 16B by means of cutting the part where the first slab waveguide 22 is formed in the waveguide chip 16 along the one cut plane 30 crossing the optical axis of the first slab waveguide 22. Accordingly, the operation to divide the plural arrayed waveguide gratings 14 can be performed by one cutting operation.

Accordingly, the respective arrayed waveguide grating type optical multiplexers and demultiplexers 2 to 4 of Embodiments 2 to 4 can be manufactured in a high productivity.

### 5. Embodiment 5

In the following, still another example of the arrayed waveguide grating type optical multiplexer and demultiplexer according to the present invention will be explained.

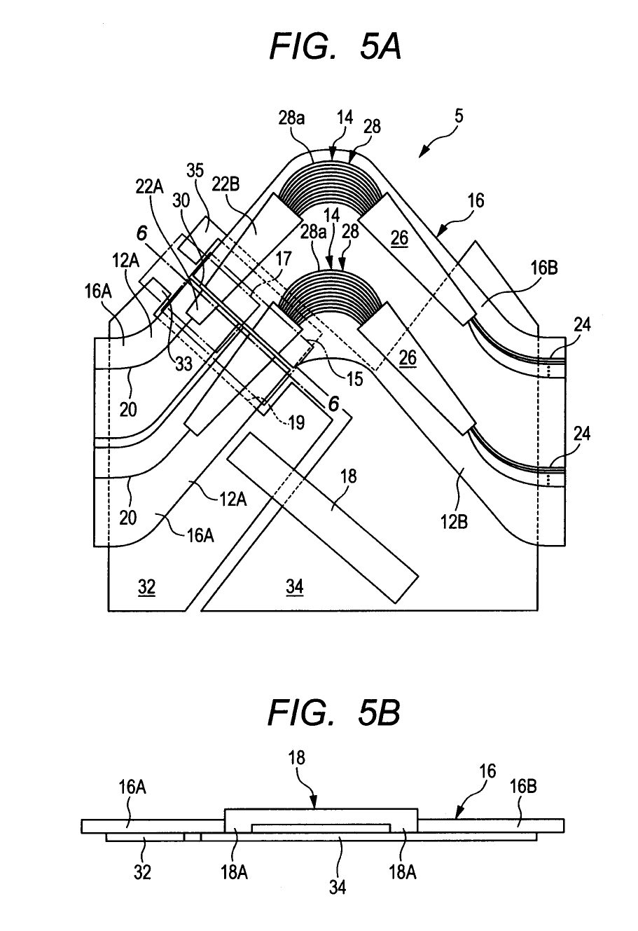

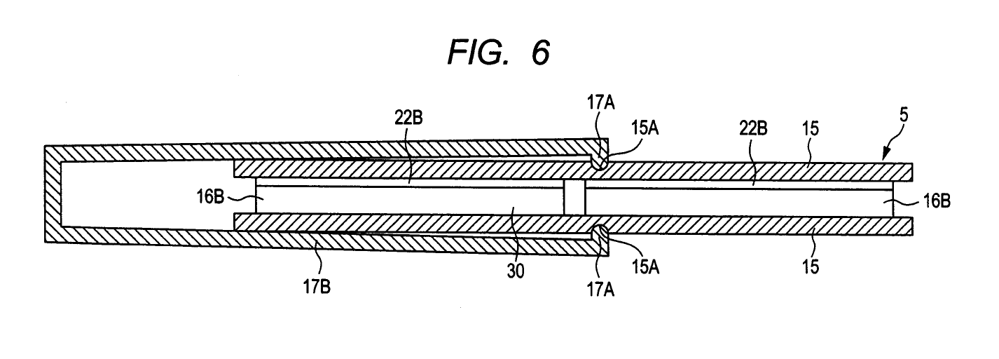

FIG. 5A and FIG. 5B show a plan view and a side view of an arrayed waveguide grating type optical multiplexer and demultiplexer 5 according to Embodiment 5, respectively. Further, FIG. 6 shows a cross section of cutting in the thickness direction along a cut plane 30 (6-6 cross section of FIG. 5A). In the arrayed waveguide grating type optical multiplexer and demultiplexer 5 according to Embodiment 5, a part where a waveguide chip 16 is cut by the cut plane 30, that is, a neighborhood of the cut plane 30 between a first separated waveguide chip 16A and a second separated waveguide chip 16B, is sandwiched between back plates 15 from both sides and sandwiched and held by a clip 17 from over the back plates 15 as shown in FIG. 6.

In the center of the back plate 15, as shown in FIG. 6, a groove 15A is formed along the optical axis of the first slab waveguide 22.

On the other hand, the clip 17 has an approximately C-shaped cross section and includes opening side edge parts 17A bent inside so as to face each other and a spring part 17B biased so as to make the opening side edge parts 17A come close to each other.

The end edge of the opening side edge part 17A in the clip 17 is formed so as to fit the groove 15A formed in the back plate 15.

A protrusion part 33 and a protrusion part 35 are formed in a first glass plate 32 and a second glass plate 34, respectively, and a rectangular opening part 19 is formed by the protrusion part 33, a remaining part of the first glass plate 32, the protrusion part 35, and a remaining part of the second glass plate 34. The positioning of the back plate 15 and the clip 17 is performed by the opening part 19. The first separated waveguide chip 16A and the second separated waveguide chip 16B are sandwiched and held by the back plates 15 and the clip 17 without mediation of either the first glass plate 32 or the second glass plate 34.

Further, a part under the arrayed waveguide 28 in the second glass plate 34 is cut out in a V-shape. That is, a part for the arrayed waveguide 28 is not fixed to either the first glass plate 32 or the second glass plate 34.

Except for the above point, the arrayed waveguide grating type optical multiplexer and demultiplexer 5 has the same configuration as the arrayed waveguide grating type optical multiplexer and demultiplexer 2 in Embodiment 2.

The arrayed waveguide grating type optical multiplexer and demultiplexer 5 has the following advantage in addition to the advantage of the arrayed waveguide grating type optical multiplexer and demultiplexer 2 according to Embodiment 2. That is, since the first separated waveguide chip 16A and the second separated waveguide chip 16B are sandwiched and held in the thickness direction by the back plates 15 and the clip 17 at the cut plane 30, that is, a boundary part thereof, a shift in the thickness direction between the first separated waveguide chip 16A and the second separated waveguide chip 16B is prevented from being caused when the first separated waveguide chip 16A is moved relatively against the second separated waveguide chip 16B by the expansion or contraction of a compensation member 18.

Further, by means of not bonding or fixing the part where the arrayed waveguide 28 is formed in the waveguide chip 16 to either the first glass plate 32 or the second glass plate 34 in this manner, an influence to the arrayed waveguide 28 which is caused by a difference between the linear expansion coefficient of the second separated waveguide chip 16B and the linear expansion coefficient of the second glass plate 34 is suppressed and it is possible to realize an arrayed waveguide grating type optical multiplexer and demultiplexer in which a low crosstalk can be obtained stably even when temperature changes.

### 6. Embodiment 6

In the following, still another example of the arrayed waveguide grating type optical multiplexer and demultiplexer according to the present invention will be explained.

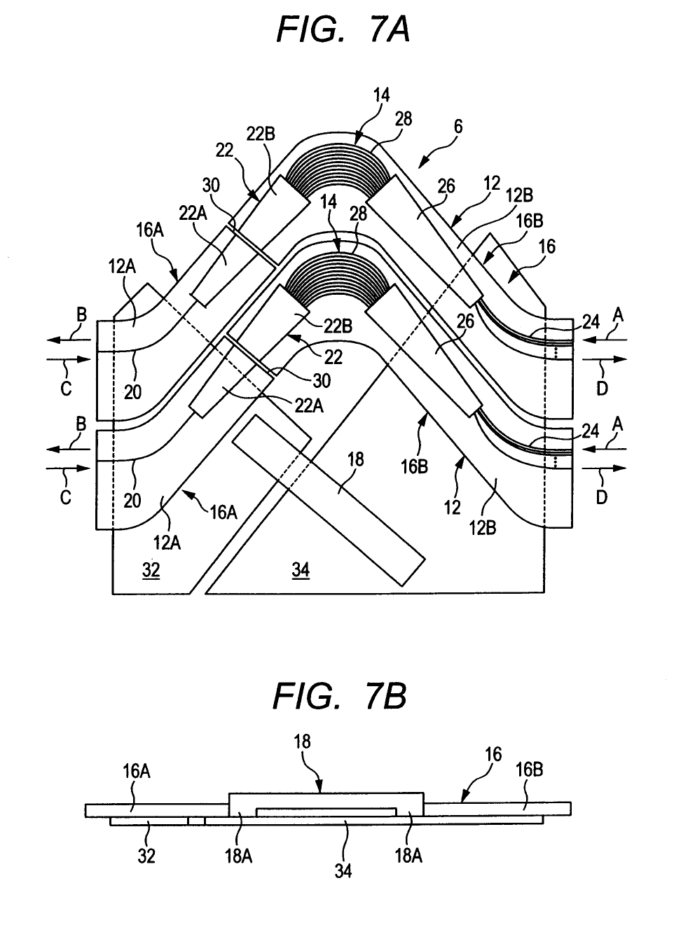

FIG. 7A and FIG. 7B show a plan view and a side view of an arrayed waveguide grating type optical multiplexer and demultiplexer 6 according to Embodiment 6, respectively. As shown in FIG. 7A and FIG. 7B, the arrayed waveguide grating type optical multiplexer and demultiplexer 6 according to Embodiment 6 has a form in which, in the arrayed waveguide grating type optical multiplexer and demultiplexer of Embodiment 1, respective parts of the first glass plate 32 and the second glass plate 34 are cut out so as to avoid the part where the respective arrayed waveguides 28 of the two second separated waveguide chips 16B are formed. Except for the above point, the arrayed waveguide grating type optical multiplexer and demultiplexer 6 according to Embodiment 6 has the same configuration as the arrayed waveguide grating type optical multiplexer and demultiplexer according to Embodiment 1.

In the arrayed waveguide grating type optical multiplexer and demultiplexer 6, since the respective parts of the first glass plate 32 and the second glass plate 34 are cut out so as to avoid the part where the arrayed waveguide 28 in the second separated waveguide chips 16B is formed, the arrayed waveguide 28 is not affected by the expansion or contraction of the second glass plate 34 even when temperature changes. Accordingly, it is possible to realize an arrayed waveguide grating type optical multiplexer and demultiplexer in which a low crosstalk can be obtained stably even when temperature changes.

### 7. Embodiment 7

In the following, still another example of the arrayed waveguide grating type optical multiplexer and demultiplexer according to the present invention will be explained.

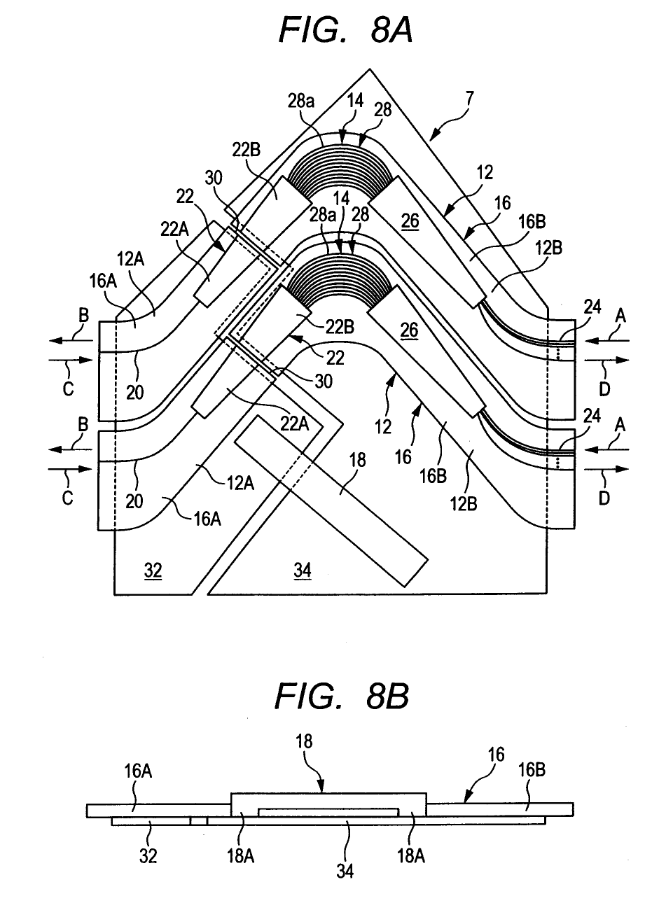

FIG. 8A and FIG. 8B show a plan view and a side view of an arrayed waveguide grating type optical multiplexer and demultiplexer 7 according to Embodiment 7, respectively. As shown in FIG. 8A and FIG. 8B, the arrayed waveguide grating type optical multiplexer and demultiplexer 7 according to Embodiment 7 has a form in which, in the arrayed waveguide grating type optical multiplexer and demultiplexer of Embodiment 1, the cut line dividing the first glass plate 32 and the second glass plate 34 is formed in a zigzag shape so as to be positioned just under the respective cut planes 30 formed in the two waveguide chips 16. Except for the above point, the arrayed waveguide grating type optical multiplexer and demultiplexer 7 according to Embodiment 7 has the same configuration as the arrayed waveguide grating type optical multiplexer and demultiplexer according to Embodiment 1.

In the arrayed waveguide grating type optical multiplexer and demultiplexer 7, since the cut line dividing the first glass plate 32 and the second glass plate 34 is formed in the zigzag shape so as to be positioned just under the respective cut planes 30 formed in the two waveguide chips 16, as described above, substantially the whole plane of the first separated waveguide chip 16A is supported from under by the first glass plate 32 in either of the two waveguide chips 16.

While, hereinabove, Embodiments 1 to 7 of the present invention have been explained, the present invention is not limited to these embodiments and it is obvious to those skilled in the art that other various embodiments can be made within the scope of the present invention. For example, while in the above embodiments, the outline of the waveguide chip 16 is cut by the use of the CO₂ laser, the present invention is not limited to this example, and the chip may be cut by the use of any of various kinds of laser, a water jet, or the like.

Further, while, in the above embodiments, the waveguide chip 16 is divided into the first separated waveguide chip 16A and the second separated waveguide chip 16B by means of cutting the part for the first slab waveguide 22 together with the substrate 12 in the direction perpendicular to the optical axis (center line) of the first slab waveguide 22, the present invention is not limited to this example, and the waveguide chip 16 may be cut in a direction obliquely crossing the optical axis (center line) of the first slab waveguide 22.

Further, while in the above embodiments, the silica glass plate is used as the substrate to which each of the first separated waveguide chip 16A and the second separated waveguide chip 16B is bonded, the present invention is not limited to this example and another material may be used if the length of the compensation member 18 is determined in consideration of a linear expansion coefficient of the material to be bonded.

Further, the bonding area of the first glass plate 32 and the first separated waveguide chip 16A, the bonding area of the second glass plate 34 and the second separated waveguide chip 16B, and the bonding position of the compensation member 18 are not limited to these embodiments, if the respective positions of the cut slab waveguides can be changed relatively by the expansion or contraction of the compensation member 18.

Further, while, in the above embodiments, the case in which one end side of the compensation member 18 is fixed to the first glass plate 32 is explained as an example, the present invention is not limited to this example and one end side of the compensation member 18 may be fixed to the first separated waveguide chip 16A. Thereby, one side of the compensation member 18 is fixed to the first glass plate 32 via the first separated waveguide chip 16A.

Further, while, in the above embodiments, the case in which the other end of the compensation member 18 is fixed to the second glass plate 34 is explained as an example, the present invention is not limited to this example and the other end of the compensation member 18 may be fixed to the second separated waveguide chip 16B by means of changing the shape of the compensation member 18 or the second separated waveguide chip 16B. Thereby, the other end of the compensation member 18 is fixed to the second glass plate 34 via the second separated waveguide chip 16B.

### (1) Example 1

The arrayed waveguide grating type optical multiplexer and demultiplexer 1 described in Embodiment 1 was fabricated and a temperature characteristic of this arrayed waveguide grating type optical multiplexer and demultiplexer 1 was evaluated.

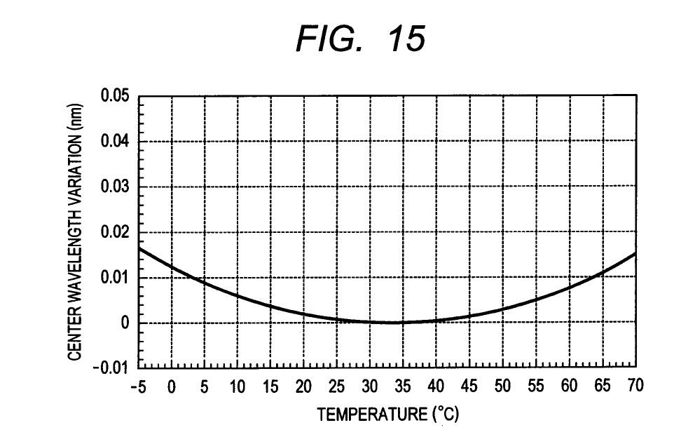

In the arrayed waveguide grating type optical multiplexer and demultiplexer 1, as shown in FIG. 15, a center wavelength variation of ±0.010 nm was realized in a temperature range of −5 to 70° C., and it was confirmed that there was not a practical problem.

Further, it has been found that, while providing a low loss, in other words, a high transmittance, for an optical signal having a wavelength of a center transmission wavelength and a neighborhood thereof at any temperature of −5° C., 20° C., 50° C. and 70° C., the arrayed waveguide grating type optical multiplexer and demultiplexer 1 provides a high loss for an optical signal having a wavelength shifted from the center transmission wavelength. In other words, it has been found that, in the arrayed waveguide grating type optical multiplexer and demultiplexer 1, an optical signal having a target frequency is transmitted in a state of including little noise at any temperature of −5° C., 20° C., 50° C. and 70° C. This is considered to show that the temperature dependence of the center transmission wavelength is compensated effectively by the expansion or contraction of the compensation member 18 even when temperature changes.

As described above, when temperature changes, while the light collection position of the first slab waveguide 22 changes, the first separated slab waveguide 22A is moved relatively against the second separated slab waveguide 22B and the light collection position is corrected by the expansion or contraction of the compensation member 18. Accordingly, even when temperature changes, plural optical signals having the respective same wavelengths (λ1 to λn) as those of input plural optical signals (λ1 to λn) can be multiplexed to be output from the first waveguide 20 in the usage for multiplexing and a multiplexed optical signal (λ1 to λn) can be divided into the respective wavelengths to be output from the second waveguide 24 in the usage for demultiplexing, and the temperature dependence of a center transmission wavelength can be compensated.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An arrayed waveguide grating type optical multiplexer and demultiplexer, comprising:
a waveguide chip having a plurality of arrayed waveguide gratings provided in parallel to one another on a substrate, each of the arrayed waveguide gratings including at least one first waveguide, a first slab waveguide connected to the first waveguide, an arrayed waveguide having one end connected to a side opposite to the first waveguide in the first slab waveguide and including a plurality of channel waveguides provided in parallel to one another, the channel waveguides having respective lengths different from one another and being bent in the same direction, a second slab waveguide connected to the other end of the arrayed waveguide, and a plurality of second waveguides connected in a state provided in parallel to one another to a side opposite to the arrayed waveguide in the second slab waveguide, wherein the waveguide chip is divided into a first separated waveguide chip and a second separated waveguide chip in the first slab waveguide or the second slab waveguide in each of the arrayed waveguide gratings; and
a compensation member compensating a temperature dependent shift of a light transmission center wavelength in the arrayed waveguide grating by being expanded and contracted according to a temperature change so that the first and second separated waveguide chips are relatively moved, wherein
the waveguide chip has a shape bending along a bending direction of the arrayed waveguide.

2. The arrayed waveguide grating type optical multiplexer and demultiplexer according to claim 1, further comprising:
a first base to which the first waveguide chip is fixed; and
a second base which is provided apart from the first base and to which the second waveguide chip is fixed, wherein
one side of the compensation member is fixed to one of the first base and the first waveguide chip, and the other side of the compensation member is fixed to the second base.

3. The arrayed waveguide grating type optical multiplexer and demultiplexer according to claim 1, wherein
one of the first waveguide chip and the second waveguide chip includes one substrate.

4. The arrayed waveguide grating type optical multiplexer and demultiplexer according to claim 1, wherein
each of the first waveguide chip and the second waveguide chip includes one substrate.

5. The arrayed waveguide grating type optical multiplexer and demultiplexer according to claim 1, wherein
a dividing part of the first waveguide chip and the second waveguide chip is sandwiched and held by a clip in a thickness direction.
